(19) United States
(12) Patent Application Publication
(10) Pub. No.: US 2026/0012556 A1
(43) Pub. Date: Jan. 8, 2026

(54) IMAGE COLLECTION DEVICE

(71) Applicant: TOYOTA JIDOSHA KABUSHIKI KAISHA, Toyota-shi Aichi-ken (JP)

(72) Inventors: Takeshi Shinoda, Fujisawa-shi (JP); Tatsuyoshi Kitamura, Koto-ku Tokyo-to (JP); Masahiro Tanaka, Edogawa-ku Tokyo-to (JP)

(73) Assignee: TOYOTA JIDOSHA KABUSHIKI KAISHA, Toyota-shi Aichi-ken (JP)

(21) Appl. No.: 19/254,777

(22) Filed: Jun. 30, 2025

(30) Foreign Application Priority Data
Jul. 3, 2024 (JP) 2024-107590

(51) Int. Cl. H04N 7/18

(52) U.S. Cl. CPC H04N 7/183

(57) ABSTRACT

The image collection device includes a memory configured to store attribute information indicating an attribute of a facility with respect to a prohibition level of image collection, and position range information indicating a position of the facility and a range of the facility, and a processor configured to set a prohibited area for prohibiting collection of an image generated by a camera being mounted on a vehicle and capturing surroundings of the vehicle, based on the attribute information and the position range information, prohibit collection of an image generated by the camera when the position of the vehicle is included in the prohibited area, and permit collection of an image generated by the camera when the position of the vehicle is out of the prohibited area.

### CROSS-REFERENCE TO RELATED APPLICATIONS

This application claims priority to Japanese Patent Application No. 2024-107590 filed Jul. 3, 2024, the entire contents of which are herein incorporated by reference.

### FIELD

The present disclosure relates to an image collection device for collecting an image generated by a camera mounted on a vehicle.

### BACKGROUND

A technique for collecting an image generated by a camera mounted on a vehicle has been proposed (see Japanese Unexamined Patent Publication No. 2021-118499). A recording control device disclosed in JP2021-118499 for recording video information obtained by an imaging device mounted on a moving object acquires storage prohibited area information in order to protect privacy pertaining to a specific place. When there is a moving object in the storage prohibited area, the recording control device executes control for prohibiting storage of video information captured in the storage prohibited area when an event related to an accident or an incident has not occurred.

### SUMMARY

Since for each facility that causes the prohibition of the storage of the video information, the shape and size of the facility differ, the shape and size of the corresponding prohibited area for each facility also differ. Therefore, it takes a great deal of time and effort to individually set the storage prohibited area. On the other hand, when the storage prohibited area is set uniformly, depending on the facility, the shape or size of the storage prohibited area becomes inappropriate, and as a result, the video information acquired at a position where the video information should not be stored may be stored, or conversely, the video information may not be stored at a position where there is no problem in storing the video information.

It is an object of the present disclosure to provide an image collection device capable of appropriately setting a range of a prohibited area while reducing man-hours for setting a prohibited area in which collection of an image generated by a camera mounted on a vehicle is prohibited.

According to one embodiment, an image collection device is provided. The image collection device includes a memory configured to store attribute information indicating an attribute of a facility with respect to a prohibition level of image collection, and position range information indicating a position of the facility and a range of the facility; and a processor configured to: set a prohibited area for prohibiting collection of an image generated by a camera being mounted on a vehicle and capturing surroundings of the vehicle, based on the attribute information and the position range information, prohibit collection of an image generated by the camera when the position of the vehicle is included in the prohibited area, and permit collection of an image generated by the camera when the position of the vehicle is out of the prohibited area.

In one embodiment, the processor sets the prohibited area by expanding a range of the facility indicated by the position range information by an offset distance corresponding to an attribute of the facility indicated by the attribute information.

In one embodiment, the processor is further configured to set, based on the attribute information and the position range information, a probe data collection prohibited area in which collection of probe data representing a predetermined feature which is provided on or around a road and is represented by the image is prohibited, wherein the probe data collection prohibited area is set to be wider than the range of the facility and narrower than the prohibited area.

In one embodiment, the processor adjusts the size of the prohibited area according to the brightness of the surrounding of the vehicle.

In one embodiment, the processor adjusts the size or shape of the prohibited area according to the orientation of the camera with respect to the facility.

The image collection device according to the present disclosure has an effect that the range of the prohibited area can be appropriately set while reducing man-hours for setting the prohibited area in which the collection of the image generated by a camera mounted on a vehicle is prohibited.

### BRIEF DESCRIPTION OF DRAWINGS

FIG. 1 schematically illustrates the configuration of an image collection system in which an image collection device is mounted.

FIG. 2 is a hardware configuration diagram of a server that is an example of an image collection device.

FIG. 3 is a functional block diagram of a processor of the server.

FIG. 4A is a schematic explanatory diagram of an image collection process.

FIG. 4B is a schematic explanatory diagram of an image collection process.

FIG. 5 is an operation flowchart of the image collection process.

### DESCRIPTION OF EMBODIMENTS

Hereinafter, an image collection device, an image collection method executed by the image collection device, and an image collection computer program will be described with reference to the drawings. The image collection device collects an image from one or more vehicles, the image being generated by a camera mounted on the vehicle, and representing a surrounding area of the vehicle. The image collection device sets a prohibited area in which collection of an image generated by the camera is prohibited, on the basis of attribute information indicating an attribute of a facility in which collection of an image is prohibited and position range information indicating a position of the facility and a range of the facility.

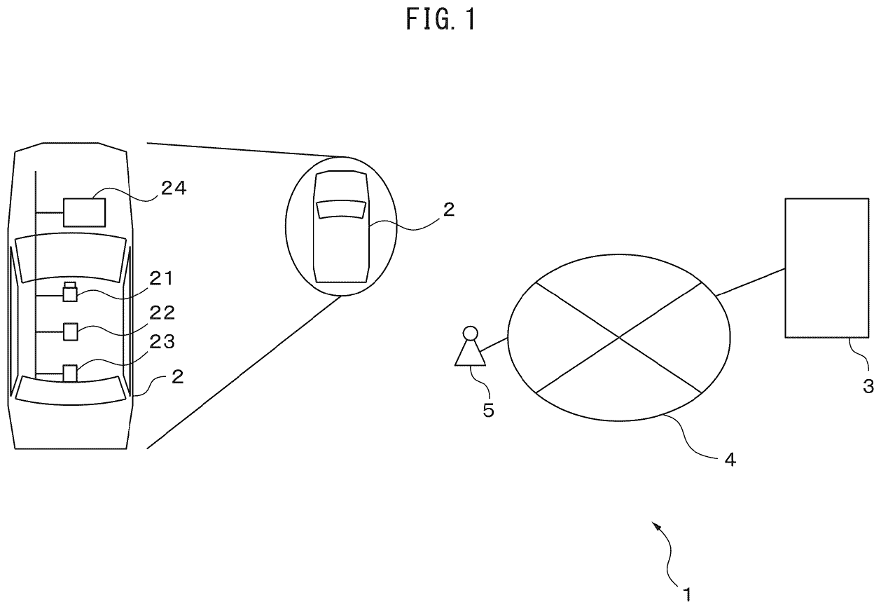

FIG. 1 schematically illustrates the configuration of an image collection system in which an image collection device is mounted. In the present embodiment, the image collection system 1 includes at least one vehicle 2 and a server 3 that is an example of an image collection device. The server 3 is connected to the communication network 4 via a gateway (not shown) or the like. The individual vehicles 2 are connected to the server 3 via the wireless base station 5 and the communication network 4 by accessing the wireless base station 5. Although only one wireless base station 5 is illustrated in FIG. 1 for simplicity, a plurality of wireless base stations 5 may be connected to the communication network 4. Similarly, although only one vehicle 2 is illustrated in FIG. 1 for simplicity, a plurality of vehicles 2 may be included in the image collection system 1.

First, the individual vehicles 2 will be described. Each of the vehicles 2 includes a camera 21, a GPS receiver 22, a wireless communication terminal 23, and a collection processing device 24. The camera 21, GPS receiver 22, the wireless communication terminal 23, and the collection processing device 24 are communicably connected.

The camera 21 is mounted on the vehicle 2 such that a predetermined area around the vehicle 2 (for example, a front region of the vehicle 2) is included in an imaging range of the camera 21. Then, the camera 21 captures the predetermined area every predetermined capturing cycle (for example, 1/30 second to 1/10 second), and generates an image in which the area is represented. The vehicle 2 may be provided with a plurality of cameras 21 having different shooting directions or different focal lengths. The camera 21 outputs the generated image together with the generation date and time to an electronic control unit (ECU, not shown) for controlling the travel of the vehicle 2 and the collection processing device 24.

The GPS receiver 22 receives GPS signals from GPS satellites at predetermined intervals, and determines the position of the vehicles 2 based on the received GPS signals. Then, GPS receiver 22 outputs, to the collection processing device 24 and the ECU, the positioning information representing the positioning data of the position of the vehicle 2 based on GPS signal together with the generation date and time at each predetermined interval. Note that the vehicle 2 may include a receiver conforming to another satellite-based positioning system other than GPS receiver 22, and the receiver may determine the position of the vehicle 2.

The wireless communication terminal 23 is a device that executes wireless communication processing conforming to a predetermined wireless communication standard, and is connected to the server 3 via the wireless base station 5 and the communication network 4 by accessing the wireless base station 5. Then, the wireless communication terminal 23 passes a collection instruction or information indicating a collection target area of data (an image or probe data representing a predetermined feature) to be collected, which is included in a downlink wireless signal received from the server 3 via the communication network 4 and the wireless base station 5, to the collection processing device 24. In addition, the wireless communication terminal 23 generates an uplink wireless signal including data of a pre-determination data for inquiring whether or not to transmit the data to be collected, an image, or probe data from the collection processing device 24. Then, the wireless communication terminal 23 transmits the uplink wireless signal to the wireless base station 5 to transmit the pre-determination data, the image, or the probe data to the server 3.

The collection processing device 24 includes at least one processor and a memory, and executes a process for uploading an image representing the surroundings of the vehicle 2 and probe data to the server 3. To this end, when receiving information representing a collection target area from the server 3 via the wireless communication terminal 23, the collection processing device 24 stores the information in a memory. Furthermore, the collection processing device 24 stores the image received from the camera 21 together with the generation date and time of the image in the memory for a certain period. Note that the collection processing device 24 deletes an image in which a certain period has elapsed from reception from the memory. Similarly, the collection processor 24 stores the positioning information received from the GPS receiver 22 together with the date and time of its generating over a certain period.

Further, the collection processing device 24 determines whether or not the position of the vehicle 2 indicated by the positioning information is included in the collection target area, and generates pre-determination data when the position of the vehicle 2 is included in the collection target area. The collection processing device 24 includes, in the pre-determination data, the position of the vehicle 2, the date and time when the position of the vehicle 2 is determined, and the identification information of the vehicle 2. The collection processing device 24 may further include, in the pre-determination data, a shooting direction of the camera 21 at the date and time when the position of the vehicle 2 is determined. The shooting direction of the camera 21 is determined based on the direction of the vehicle 2 detected by an azimuth sensor (not shown) mounted on the vehicle 2 and the mounting direction of the camera 21 with respect to the vehicle 2. Furthermore, the collection processing device 24 may also include a parameter of the camera 21, such as an angle of view or a focal length of the camera 21, in the pre-determination data. The collection processing device 24 transmits the generated pre-determination data to the server 3 via the wireless communication terminal 23.

Furthermore, when receiving an image collection instruction from the server 3 via the wireless communication terminal 23 after the transmission of the pre-determination data, the collection processing device 24 transmits an image of the generation date and time closest to the date and time when the position of the vehicle 2 was measured and included in the pre-determination data to the server 3 via the wireless communication terminal 23 together with the position information of the vehicle 2. Further, when receiving the probe data collection instruction from the server 3 via the wireless communication terminal 23 after the transmission of the pre-determination data, the collection processing device 24 transmits the probe data generated from the image of the generation date and time closest to the date and time when the position of the vehicle 2 was measured and included in the pre-determination data to the server 3 via the wireless communication terminal 23.

The collection processing device 24 detects a predetermined feature from the latest image generated by the camera 21 at every predetermined cycle or every time the vehicle 2 travels a predetermined distance while the position of the vehicle 2 is included in the collection target area. Note that the predetermined feature is a feature represented by the map information, and is, for example, various road signs, various road markings, curbstones, guardrails, traffic lights, a pole for installing a road sign, and the like.

The collection processing device 24 detects a predetermined feature represented in the input image by inputting the image to a classifier. The classifier is configured as a deep neural network (DNN) with a convolutional neural network (CNN) type architecture, such as a Single Shot MultiBox Detector. Alternatively, the classifier may be configured as a DNN with attention mechanisms, such as a Vision Transformer, or a classifier based on other machine-learning techniques, such as an AdaBoost classifier. Such a classifier is trained in advance according to a predetermined learning method such as a back propagation method using a large number of teacher images in which a predetermined feature is represented so as to detect the feature from the image. The classifier outputs information indicating a region including the detected feature on the input image (for example, a circumscribing rectangle of the detected feature, hereinafter referred to as an object region), and information indicating a type of the feature represented in the object region.

The collection processing device 24 estimates the position of the feature represented in the object region on the basis of parameters such as the orientation from the camera 21 corresponding to the centroid of the object region detected from the image, the position of the vehicle 2 at the time of image generation, the traveling direction, the shooting direction, the focal length, and the installation position of the camera 21. At this time, the collection processing device 24 may estimate the position of the feature by a so-called Structure from Motion (SfM). In this case, the collection processing device 24 associates object regions in which the same feature is represented by a predetermined tracking process between two images obtained at different timings. The collection processing device 24 may estimate the position of the feature by triangulation on the basis of the position and the traveling direction of the vehicle 2 when each of the two images is obtained, the parameter of the camera 21, and the position of the object region in each image. The collection processing device 24 then generates probe data including information representative of the detected feature type and the estimated position. The collection processing device 24 may further include information indicating the position and the traveling direction of the vehicle 2 at the time of image generation in the probe data. The collection processing device 24 may further include information representing the size of the object region and the position on the image in the probe data.

Hereinafter, the server 3, which is an example of the image collection device, will be described.

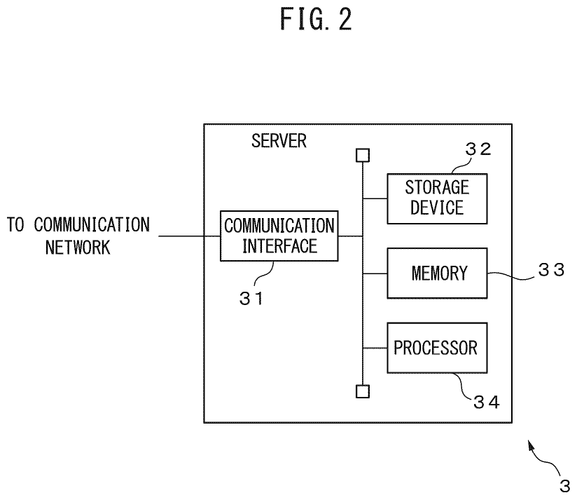

FIG. 2 is a hardware configuration diagram of the server 3, which is an example of the image collection device. The server 3 includes a communication interface 31, a storage device 32, a memory 33, and a processor 34. The communication interface 31, the storage device 32, and the memory 33 are connected to the processor 34 via a signal line. The server 3 may further include an input device such as a keyboard and a mouse, and a display device such as a liquid crystal display.

The communication interface 31 is an example of a communication unit, and includes an interface circuit for connecting the server 3 to the communication network 4. The communication interface 31 then passes the pre-determination data, image or probe data received from the individual vehicles 2 via the wireless base stations 5 and the communication network 4 to the processor 34. In addition, the communication interface 31 transmits the information representing the collection target area received from the processor 34 to each vehicle 2 via the communication network 4 and the wireless base station 5. Further, the communication interface 31 transmits the collection instruction signal received from the processor 34 to the vehicle 2 to be subjected to the collection instruction via the communication network 4 and the wireless base station 5.

The storage device 32 is an example of a storage unit, and includes, for example, a hard disk device, an optical recording medium, and an access device thereof. Then, the storage device 32 stores information indicating the collection target area, position range information indicating the position and range of each facility in the collection target area, and attribute information indicating the attribute of the facility related to the prohibition level of image collection.

The storage device 32 further stores, for each of the plurality of road sections included in the collection target area, the probe data and the image collected for the road section. Further, the storage device 32 may store map information updated based on the collected image and probe data. Furthermore, the storage device 32 may store a computer program for executing an image collection process, which is executed on the processor 34.

The memory 33 is another example of a storage unit, and includes, for example, a nonvolatile semiconductor memory and a volatile semiconductor memory. The memory 33 temporarily stores various data generated during the execution of the image collection process, various data acquired by communication with the individual vehicles 2 such as the pre-determination data, and the like.

The processor 34 includes one or more central processing units (CPUs) and its peripheral circuitry. The processor 34 may further include other arithmetic circuits such as a logical arithmetic unit or a numerical value arithmetic unit. Then, the processor 34 executes the image collection process and stores the probe data or the image received from each vehicle 2 as a result of the image collection process in the storage device 32.

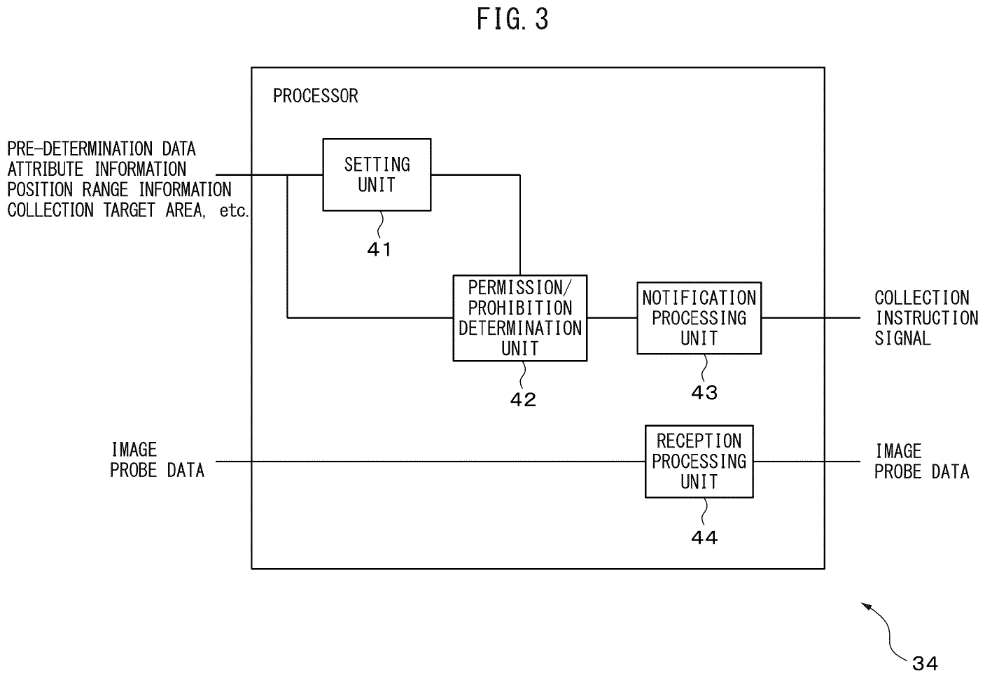

FIG. 3 is a functional block diagram of the processor 34 of the server 3. The processor 34 includes a setting unit 41, a permission/prohibition determination unit 42, a notification processing unit 43, and a reception processing unit 44. Each of these units included in the processor 34 is, for example, a functional module implemented by a computer program executed by the processor 34. Alternatively, each of these units included in the processor 34 may be a dedicated operating circuit provided in the processor 34.

When the server 3 receives the pre-determination data, the setting unit 41 refers to the position range information of each facility and specifies a facility that exists within a predetermined distance from the position of the vehicle 2 indicated by the pre-determination data. Then, the setting unit 41 sets a prohibited area in which collection of an image generated by the camera 21 of the vehicle 2 is prohibited based on the attribute information and the position range information of the specified facility.

In the present embodiment, the offset distance is set according to the attribute of the facility indicated in the attribute information. The setting unit 41 sets, for each facility, the prohibited area by increasing the range of the facility indicated by the position range information of the facility by an offset distance. For example, the setting unit 41 sets, for each position on the outer edge of the range of the facility, a point separated from the position on the outer edge by the offset distance along a line connecting the position on the outer edge and the centroid of the range of the facility, or a point separated from the position on the outer edge by the offset distance along a direction orthogonal to the tangent of the outer edge of the facility at the position, as a position on the outer edge of the prohibited area. Then, the setting unit 41 may set the prohibited area by connecting the individual positions on the outer edge of the prohibited area. As described above, since the setting unit 41 automatically adjusts the range of the prohibited area in accordance with the attribute of the facility, it is possible to appropriately set the range of the prohibited area while reducing man-hours for setting the prohibited area.

The attribute of the facility is set in advance according to a difference in a prohibition level with respect to the collection of an image representing the facility and its surroundings. For example, the attributes of the facilities are set differently for an airport, a hospital, and a military facility. Further, the attribute of a facility may be individually set according to the clinical subjects of a hospital. For example, the attribute for a dental hospital may be set differently from the attribute for a neurological hospital. Then, the offset distance is set to a larger value as the prohibition level for image collection indicated by the attribute of the facility is higher. For example, the offset distance to the military facility is set to the largest value, and the offset distance decreases in the order of the airport and the hospital.

Note that the prohibited area for the image collection and the prohibited area for the probe data collection (that is, the probe data collection prohibited area) may be set separately. In this case, depending on the attribute of the facility, the offset distance with respect to the probe data may be set to a smaller value than the offset distance with respect to the image. For example, for a military facility, the same offset distance may be set for the image and probe data, while for an airport and a hospital, the offset distance for the probe data may be set to a smaller value than the offset distance for the image. As a result, the probe data collection prohibited area is a wider area than the range of the facility and narrower than the prohibited area for the image. This is because, unlike the image, the probe data represents only a predetermined type feature. As described above, since the offset distance is set individually between the image and the probe data, the setting unit 41 can appropriately set the range of the prohibited area for the probe data that is less restricted than the image.

The shape of the prohibited area is a polygon in order to correspond to the shapes of various facilities. However, the shape of the prohibited area may be another shape that is simpler than a polygon, such as a circle or an ellipse. In this case, the setting unit 41 may set the prohibited area as a circumscribed circle or a circumscribed ellipse of the prohibited area based on the polygon shape by approximating the shape of the prohibited area based on the polygon with another shape such as a circle or an ellipse as described above. In some embodiments, in the case where the prohibited area has any shape, the setting unit 41 sets the prohibited area such that the distance from the outer edge of the range of the facility to the nearest point on the outer edge of the prohibited area is equal to or larger than the offset distance corresponding to the attribute of the facility.

The setting unit 41 notifies the permission/prohibition determination unit 42 of the set prohibited area for each facility. When the prohibited area is set individually for the image and the probe data for the same facility, the setting unit 41 notifies the permission/prohibition determination unit 42 of both the prohibited area for the image and the prohibited area for the probe data.

The permission/prohibition determination unit 42 determines whether or not the position of the vehicle 2 indicated by the pre-determination data is included in the prohibited area set for each facility. When the position of the vehicle 2 is included in the prohibited area set for any of the facilities, the permission/prohibition determination unit 42 prohibits collection of an image generated by the camera 21 of the vehicle 2. On the other hand, when the position of the vehicle 2 is outside the prohibited area for each facility, the permission/prohibition determination unit 42 permits the collection of an image generated by the camera 21 of the vehicle 2. When the prohibited area related to the probe data and the prohibited area related to the image are separately set, the permission/prohibition determination unit 42 also determines whether or not the position of the vehicle 2 is included in the prohibited area related to the probe data. Then, the permission/prohibition determination unit 42, when the position of the vehicle 2 is also outside the prohibited area relating to the probe data for each facility, the permission/prohibition determination unit 42 permits the collection of the probe data.

In addition, the memory 33 may store a road section associated with a name (for example, a hospital name) of a specific facility to which image collection is prohibited (hereinafter referred to as a prohibited road section). In this case, even if the position of the vehicle 2 is outside the prohibited area for each facility, when the position of the vehicle 2 is included in the prohibited road section, the permission/prohibition determination unit 42 may prohibit the collection of the image generated by the camera 21 of the vehicle 2.

Note that data to be collected may be individually set for each road section or each partial area in the collection target area. In this case, only when the data to be collected in the road section or the partial region including the position of the vehicle 2 is an image and the position of the vehicle 2 is outside the prohibited area related to the image for each facility, the permission/prohibition determination unit 42 may permit the collection of the image generated by the camera 21 of the vehicle 2. Similarly, only when the data to be collected in the road section or the partial area including the position of the vehicle 2 is probe data and the position of the vehicle 2 is outside the prohibited area related to the probe data for each facility, the permission/prohibition determination unit 42 may permit the collection of the probe data.

The permission/prohibition determination unit 42 notifies the notification processing unit 43 of the determination result of the collection permission/prohibition of the image and the determination result of the collection permission/prohibition of the probe data together with the identification information of the vehicle 2 included in the pre-determination data.

The notification processing unit 43 notifies the individual vehicles 2 of the information indicating the collection target area via the communication interface 31, the communication network 4, and the wireless base station 5 at predetermined intervals or at predetermined dates and times. Further, the notification processing unit 43 receives, from the permission/prohibition determination unit 42, a determination result that the collection of the image or the probe data is permitted for the vehicle 2 that has transmitted the pre-determination data, and generates a collection instruction signal including the identification information of the vehicle 2 and a flag indicating that the collection is permitted among the image and the probe data. Then, the notification processing unit 43 transmits the generated collection instruction signal to the vehicle 2 that has transmitted the pre-determination data via the communication interface 31, the communication network 4, and the wireless base station 5.

Each time the probe data or image is received from the vehicle 2, the reception processing unit 44 stores the received probe data or image in the storage device 32. At this time, the reception processing unit 44 may count the number of received images and the number of probe data for each road section. In this case, each time an image is received, the reception processing unit 44 refers to the position of the vehicle 2 received together with the image, identifies the road section in which the vehicle 2 was traveling when the image was generated, and increments the count value of the image for the identified road section by 1. Similarly, each time the probe data is received, the reception processing unit 44 refers to the position of the vehicle 2 included in the probe data, identifies the road section in which the vehicle 2 was traveling when the probe data was generated, and increments the count value of the probe data for the identified road section by 1.

Further, on the basis of the collected probe data for a road section in which a predetermined number or more of probe data are collected (hereinafter referred to as an update target section), the reception processing unit 44 may update information on a predetermined feature of the update target section represented in the map information. To this end, the reception processing unit 44 aligns, for each vehicle 2 that has traveled in the update target section, each feature represented by the series of probe data received from the vehicle 2 and the corresponding feature represented by the map information. At this time, the reception processing unit 44 calculates the affine transform coefficients according to a predetermined optimization method such as the steepest descent method so that the sum of squares of the distances between the positions of the individual features represented in the series of probe data and the corresponding features represented in the map information is minimized. Then, the reception processing unit 44 moves the positions of the individual features represented by the series of probe data using the calculated affine transform coefficients, thereby aligning the features with the corresponding features represented by the map information. Then, for the feature represented by the predetermined number or more of probe data and estimated to be the same, the reception processing unit 44 adds the type and the position of the feature to the map information when the corresponding feature is not represented in the map information. On the other hand, among the features represented in the map information, the reception processing unit 44 deletes, from the map information, the information about the feature for which no probe data has been collected that represents a corresponding feature within a predetermined distance. Further, it is assumed that a distance between a predetermined feature represented in the map information and a feature which is represented in the received predetermined number or more of probe data and has a type same as that of the predetermined feature is farther than a predetermined distance. In this case, the reception processing unit 44 corrects the position of the feature represented in the map information to an average value of the positions of the feature represented in the received predetermined number or more of probe data.

Further, when the feature is detected from the image received from the vehicle traveling in the update target section, the reception processing unit 44 may add information on the detected feature to the map information. In this case, the reception processing unit 44 may detect a feature by inputting an image to a classifier similar to the classifier used by the collection processing device 24 of the vehicle 2 to generate the probe data. Further, the reception processing unit 44 may estimate the position of the detected feature based on the position of the vehicle 2 at the time of image generation, the shooting direction of the camera 21, the parameters of the camera 21, and the position of the feature on the image.

The reception processing unit 44 stores the updated map information in the storage device 32. Furthermore, the notification processing unit 43 may output the updated map information to another device via the communication interface 31 and the communication network 4. Furthermore, the notification processing unit 43 may distribute the updated map information to the vehicle 2 or another vehicle that uses the map information for autonomous driving control via the communication interface 31, the communication network 4, and the wireless base station 5.

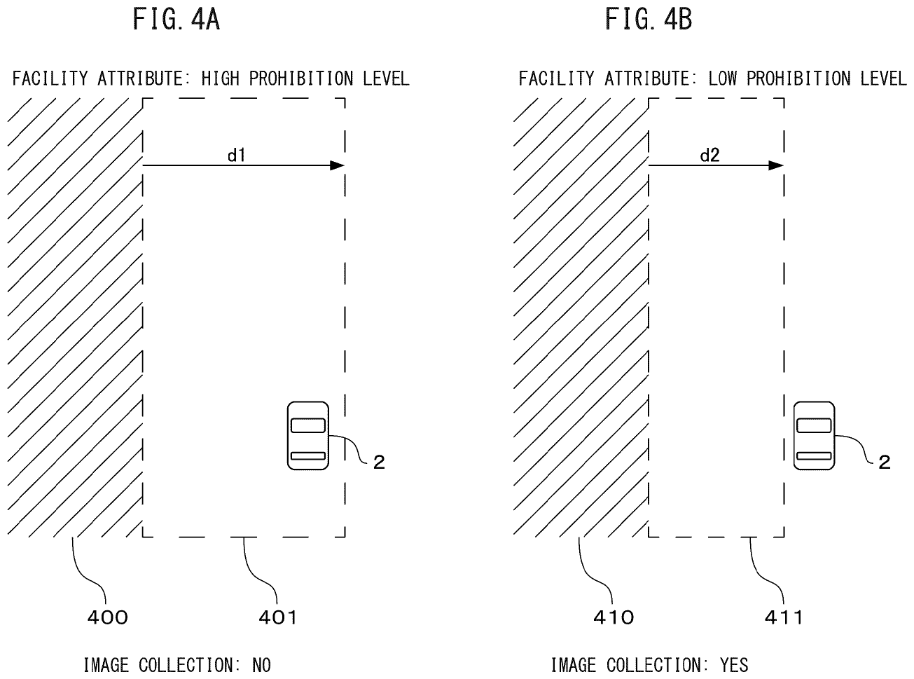

FIGS. 4A and 4B are schematic explanatory diagrams of an image collection process. In the embodiment shown in FIG. 4A, the prohibited area 401 is set by expanding the area of the facility 400 by the offset-distance d1. Since the facility 400 has a relatively high-prohibition level for image collection, the offset-distance d1 is also set to a relatively large value. As a result, the position of the vehicle 2 is included in the prohibited area 401, and image collection is prohibited.

In the embodiment shown in FIG. 4B, the prohibited area 411 is set by expanding the area of the facility 410 by the offset-distance d2. Since the facility 410 has a relatively low prohibition level for image collection, the offset-distance d2 is also set to a relatively small value. As a result, the position of the vehicle 2 is out of the prohibited area 411 and image collection from the vehicle 2 is allowed.

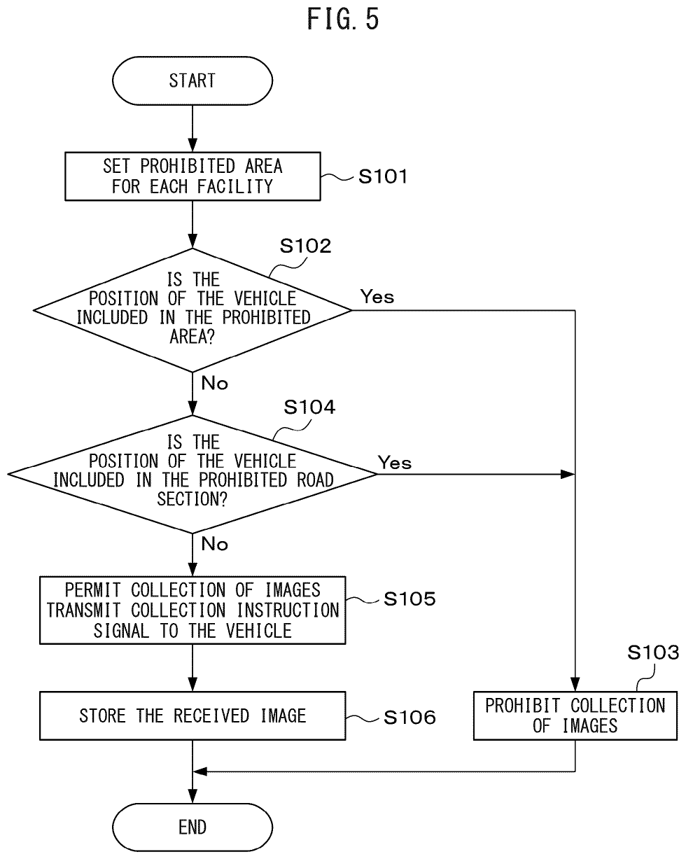

FIG. 5 is an operation flowchart of the image collection process.

The setting unit 41 sets a prohibited area in which collection of an image generated by the camera 21 of the vehicle 2 is prohibited on the basis of the attribute information and the position range information of each facility existing within a predetermined distance from the position of the vehicle 2 indicated by the pre-determination data (step S101). The permission/prohibition determination unit 42 determines whether or not the position of the vehicle 2 is included in the prohibited area set for each facility (step S102).

When the position of the vehicle 2 is included in the prohibited area of any of the facilities (Yes in step S102), the permission/prohibition determination unit 42 prohibits collection of an image generated by the camera 21 of the vehicle 2 (step S103). The notification processing unit 43 does not transmit the collection instruction signal to the vehicle 2.

On the other hand, when the position of the vehicle 2 deviates from the prohibited area of each facility (No in step S102), the permission/prohibition determination unit 42 determines whether or not the position of the vehicle 2 is included in the prohibited road section (step S104). When the position of the vehicle 2 is included in the prohibited road section (Yes in step S104), the permission/prohibition determination unit 42 prohibits collection of an image generated by the camera 21 of the vehicle 2 (step S103). On the other hand, when the position of the vehicle 2 is out of the prohibited road section (No in step S104), the permission/prohibition determination unit 42 permits collection of an image generated by the camera 21 of the vehicle 2. Then, the notification processor 43 generates a collection instruction signal instructing collection of an image, and transmits the generated collection instruction signal to the vehicle 2 via the communication interface 31, the communication network 4, and the wireless base station 5 (step S105).

When an image is received from the vehicle 2 after the collection instruction signal is transmitted, the reception processor 44 stores the received image in the storage device 32 (step S106). After the step S103 or the step S106, the processor 34 ends the image collection process. When the prohibited area is set separately from the images with respect to the probe data, the processor 34 may also execute the process of the step S101 to S106 with respect to the probe data.

As described above, the image collection device sets a prohibited area in which collection of an image generated by a camera mounted on a vehicle is prohibited on the basis of the attribute information of the facility and the position range information indicating the position of the facility and the range of the facility. Therefore, the image collection device can appropriately set the range of the prohibited area while reducing man-hours for setting the prohibited area in which the collection of the image generated by a camera mounted on a vehicle is prohibited.

According to the modification, the setting unit 41 may adjust the size of the prohibited area according to the brightness of the surroundings of the vehicle 2. The darker the surroundings of the vehicle 2, the more obscured on an image generated by the camera 21 is an object located at a distance from the vehicle 2. Therefore, the setting unit 41 corrects such that the darker the surroundings of the vehicle 2 are, the shorter the offset distance set according to the attribute of the facility is. Thus, the darker the surroundings of the vehicle 2 are, the smaller the prohibited area is.

For example, the collection processing device 24 of the vehicle 2 includes, in the pre-determination data, a measurement value immediately before generating of the pre-determination data by a rainfall sensor (not shown) of the vehicle 2 as an index value representing the brightness around the vehicle 2. When the measured value of the rainfall exceeds a predetermined threshold value, the setting unit 41 shortens the offset distance corresponding to the attribute of the facility by the predetermined adjustment amount. Alternatively, the setting unit 41 may increase the adjustment amount for shortening the offset distance as the measured value of the rainfall amount increases. In addition, the collection processing device 24 may include, in the pre-determination data, a measurement value immediately before generating of the pre-determination data by an illuminance sensor (not shown) of the vehicle 2 as an index value representing the brightness around the vehicle 2. When the measured value of the illuminance becomes less than the predetermined threshold value, the setting unit 41 may shorten the offset distance corresponding to the attribute of the facility by a predetermined adjustment amount. Alternatively, the setting unit 41 may increase the adjustment amount for reducing the offset distance as the measured value of the illuminance decreases. Further, in a case where the reception time of the pre-determination data is included in the nighttime zone, the setting unit 41 may shorten the offset distance corresponding to the attribute of the facility by a predetermined adjustment amount.

According to another modification, the setting unit 41 may adjust the size or shape of the prohibited area according to the orientation of the camera 21 with respect to the facility. For example, in a case where the shooting direction of the camera 21 included in the pre-determination data is oriented to a direction away from the facility, the setting unit 41 may shorten the offset distance corresponding to the attribute of the facility by a predetermined adjustment amount. Further, the setting unit 41 may refer to the shooting direction and the angle of view of the camera 21 and the position of the vehicle 2 included in the pre-determination data and the map information to determine whether or not there is a shield such as a building or a fence between the facility and the shooting range of the camera 21. When there is such a shield, the setting unit 41 may shorten the offset distance corresponding to the attribute of the facility by a predetermined adjustment amount. Alternatively, the setting unit 41 may change the shape of the prohibited area so as to remove, from the prohibited area, an area that is shielded by the shield as viewed from the facility side. By thus adjusting the size or shape of the prohibited area according to the shooting direction of the camera 21, the setting unit 41 can more appropriately set the prohibited area.

Note that, depending on the positional relationship between the position and the direction of the vehicle 2 and the outer edge of the prohibited area, a part of the image generated by the camera 21 may represent an area outside the prohibited area even if the vehicle 2 is located in the prohibited area. Therefore, the permission/prohibition determination unit 42 may determine whether or not a region outside the prohibited area is represented in a part of the image generated by the camera 21 with reference to the shooting direction and the angle of view of the camera 21 indicated in the pre-determination data and the position of the vehicle 2. When a region of the prohibited area is represented in a part of the image, the notification processing unit 43 may include, in the collection instruction signal, information indicating a range in which a region outside the prohibited area is represented on the image, and a flag value indicating that a partial image of the range is transmitted to the server 3. In this case, the collection processing device 24 of the vehicle 2 cuts out the range indicated by the collection instruction signal received from the server 3 from the image to generate a partial image, and transmits the generated partial image to the server 3 via the wireless communication terminal 23.

According to still another modification, a microphone for collecting sound outside the vehicle 2 may be mounted on the vehicle 2. The collection processing device 24 calculates an average value of the sound volume around the vehicle 2 collected by the microphone in a predetermined period (for example, several seconds to one minute) immediately before generation of the pre-determination data, and may include the average value of the sound volume in the pre-determination data. Then, when the average value of the volume around the vehicle 2 exceeds the predetermined upper limit volume threshold, the permission/prohibition determination unit 42 may prohibit the collection of an image even if the position of the vehicle 2 is out of the prohibited area. Accordingly, when a large number of people or other vehicles exist around the vehicle 2, the collection of an image representing those people or vehicles is suppressed.

The processing of the setting unit 41 and the permission/prohibition determination unit 42 according to the above-described embodiment or modification may be executed by the processor of the collection processing device 24 of the vehicle 2. At this time, the attribute information and the position range information of each facility are stored in advance in the memory of the collection processing device 24. When the processor of the collection processing device 24 determines that the position of the vehicle 2 is not included in the prohibited area for any facility, the image or probe data may be transmitted to the server 3 via the wireless communication terminal 23.

The computer program for achieving the functions of the processor 34 of the server 3 according to the above-described embodiment or modified examples may be provided in a form recorded on a computer-readable portable storage medium, such as a semiconductor memory, a magnetic medium, or an optical medium.

As described above, a skilled person can make various modifications according to the embodiment within the scope of the present disclosure.

What is claimed is:

1. An image collection device comprising:
a memory configured to store attribute information indicating an attribute of a facility with respect to a prohibition level of image collection, and position range information indicating a position of the facility and a range of the facility; and
a processor configured to:
set a prohibited area for prohibiting collection of an image generated by a camera being mounted on a vehicle and capturing surroundings of the vehicle, based on the attribute information and the position range information,
prohibit collection of an image generated by the camera when the position of the vehicle is included in the prohibited area, and
permit collection of an image generated by the camera when the position of the vehicle is out of the prohibited area.

2. The image collection device according to claim 1, wherein the processor sets the prohibited area by expanding a range of the facility indicated by the position range information by an offset distance corresponding to an attribute of the facility indicated by the attribute information.

3. The image collection device according to claim 1, wherein the processor is further configured to set, based on the attribute information and the position range information, a probe data collection prohibited area in which collection of probe data representing a predetermined feature which is provided on or around a road and is represented by the image is prohibited, wherein the probe data collection prohibited area is set to be wider than the range of the facility and narrower than the prohibited area.

4. The image collection device according to claim 1, wherein the processor adjusts a size of the prohibited area according to a brightness of the surrounding of the vehicle.

5. The image collection device according to claim 1, wherein the processor adjusts a size or shape of the prohibited area according to an orientation of the camera with respect to the facility.
